(19) United States
(12) Patent Application Publication
(10) Pub. No.: US 2013/0097538 A1
(43) Pub. Date: Apr. 18, 2013

(54) METHOD AND APPARATUS FOR DISPLAYING ICONS ON MOBILE TERMINAL

(71) Applicant: Samsung Electronics Co., Ltd., Gyeonggi-do (KR)

(72) Inventors: Sehwan PARK, Gyeonggi-do (KR); Youngjoo Park, Gyeonggi-do (KR)

(73) Assignee: Samsung Electronics Co., Ltd., Gyeonggi-do (KR)

(21) Appl. No.: 13/653,838

(22) Filed: Oct. 17, 2012

(30) Foreign Application Priority Data
Oct. 17, 2011 (KR) 10-2011-0106018

(51) Int. Cl. G06F 3/048

(52) U.S. Cl. 715/765

(57) ABSTRACT

A method and an apparatus for displaying icons on a mobile terminal by displaying icons, receiving an edit command for editing an arranged state of the icons, checking an arrangement rule corresponding to the edit command, and arranging and displaying the icons according to the arrangement rule. Because the arranged state of icons is edited and restored with a simple operation, intuitive use is improved.

### PRIORITY

This application claims priority under 35 U.S.C. §119(a) to Korean Patent Application Serial No. 10-2011-0106018, which was filed in the Korean Intellectual Property Office on Oct. 17, 2011, the entire disclosure of which is incorporated herein by reference.

### BACKGROUND OF THE INVENTION

1. Field of the Invention

The present invention relates generally to a method and an apparatus for displaying icons on a mobile terminal, and more particularly, to a method for editing an arranged state of icons by only a simple operation and restoring the arranged state of the icons to a previous state, and an apparatus thereof.

2. Description of the Related Art

In recent years, various types of application programs that may be installed in mobile terminals have become available. A user may directly install various applications such as electronic organizer applications, memo applications, and the like, which may also be provided in a mobile terminal as default applications. As the number of application provided by mobile terminals increases, a need for a user interface capable of easily managing and using mobile applications has emerged.

Icons are generally provided in a user interface for displaying the installed applications. Icons may be arranged and displayed in the order in which the applications are installed or in the order which the icons are created. Generally, up to 12-16 icons are simultaneously displayed for each screen page of the mobile terminal. If the total number of icons exceeds the maximum for a screen page, a next page is created to display the icons that are not displayed on the current page. However, in this method, when many applications are installed in a mobile terminal, in many cases, it may be difficult to search for a particular application and edit the arrangement of the icons. For example, when 100 applications are installed on a device where 16 icons are displayed for each page, a user must search through 6 pages of icons. Although folders may be used, if a user has not memorized the location of a folder containing the specific icon, the user must open and search each folder in order to find the specific icon. As the number of icons increases, it becomes more difficult to edit the arrangement of the icons. For example, in order to transfer both an icon displayed on the sixth page and an icon displayed on the fifth page to a first page, the user has to separately transfer each icon, and therefore, the process of transferring both icons takes a long time.

### SUMMARY OF THE INVENTION

The present invention has been made in view of the above problems and/or disadvantages, and provides a method for displaying icons and editing an arranged state of icons with simple operations and editing and restoring the arranged state of icons according to an input direction of a gesture, and an apparatus thereof.

According to an aspect of the present invention, there is provided a method for displaying icons which includes displaying icons in an arranged state, receiving an edit command for editing the arranged state of the icons, checking an arrangement rule corresponding to the edit command, and arranging and displaying the icons according to the arrangement rule.

According to another aspect of the present invention, there is provided an apparatus for displaying icons which includes a display unit for displaying icons in an arranged state, an input unit for receiving user input, and a controller for determining whether the user input received by the input unit is an edit command for editing the arranged state of the icons, checking an arrangement rule corresponding to the edit command when the user input is the edit command, and controlling such that the icons arranged and displayed according to the arrangement rule.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating an internal configuration of an apparatus for displaying icons according to an embodiment of the present invention;

FIG. 2 is a flowchart illustrating a method for editing an arranged state of icons according to an embodiment of the present invention;

FIG. 3 is a flowchart illustrating a forming procedure of Step 260 of FIG. 2, according to an embodiment of the present invention;

FIG. 4 is a flowchart illustrating a procedure for restoring an arranged state of icons, according to an embodiment of the present invention;

FIG. 5 is a diagram illustrating an edit command and a restoration command having input directions opposite of each other, according to an embodiment of the present invention;

FIG. 6 is a diagram illustrating an example of a graphic interface for editing an arranged state of icons and restoring the arranged state of icons to a previous state according to an embodiment of the present invention;

FIG. 7 is a diagram illustrating another example of a graphic interface for editing an arranged state of icons and restoring the arranged state of icons to a previous state according to an embodiment of the present invention;

FIG. 8 is a diagram illustrating an example of a graphic interface for restoring an arranged state of icons to a previous state where a new icon exists, according to an embodiment of the present invention; and

FIG. 9 is a diagram illustrating an example of a graphic interface for restoring an arranged state of icons to a restoration time-point selected by a user, according to an embodiment of the present invention.

### DETAILED DESCRIPTION OF EMBODIMENTS OF THE PRESENT INVENTION

Various embodiments of the present invention are described as follows with reference to the accompanying drawings. The same reference numbers are used throughout the drawings to refer to the same or like components. Detailed descriptions of well-known functions and structures are omitted to avoid obscuring the subject matter of the present invention.

In the following description, the term “icon” is a unit displayed on a display screen of a mobile terminal in order to identify and/or to be selected in order to execute applications, folders, and widgets. Icons may be displayed according to optional forms, shapes, colors, or a combination thereof.

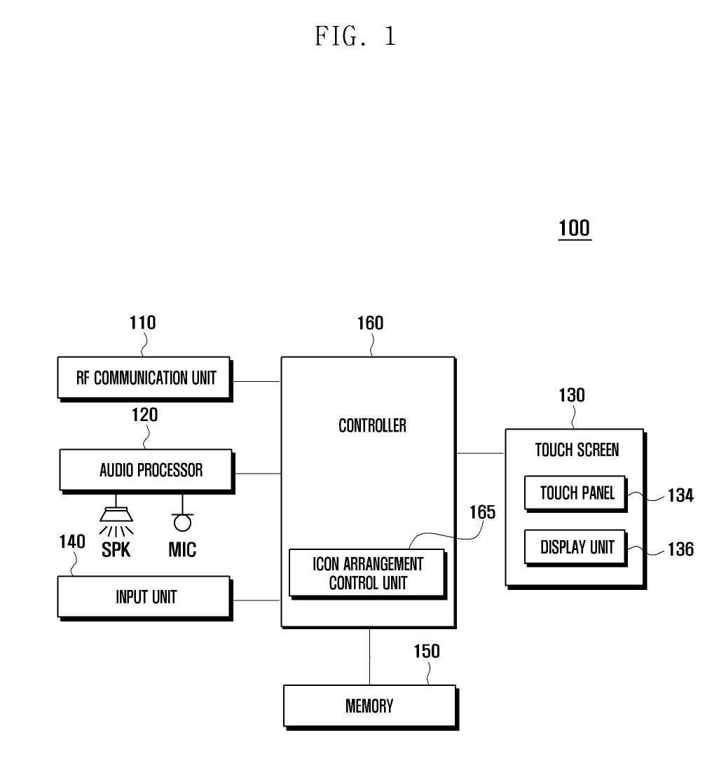

FIG. 1 is a block diagram illustrating an internal configuration of an apparatus for displaying icons according to an embodiment of the present invention.

Referring to FIG. 1, a mobile terminal 100 according to an embodiment of the present invention may include a Radio Frequency (RF) communication unit 110, an audio processor 120, a touch screen 130, an input unit 140, a memory 150, and a controller 160.

The RF communication unit 110 transmits and receives corresponding data for RF communication of the mobile terminal 100. The RF communication unit 110 may include an RF transmitter up-converting a frequency of a transmitted signal and amplifying the signal, and an RF receiver low-noise-amplifying a received signal and down-converting the signal (not shown). Further, the RF communication unit 100 receives data through an RF channel and outputs the received data to the controller 160. The RF communication unit 110 transmits data output from the controller 160 through the RF channel.

The audio processor 120 is implemented with a Coder/Decoder (CODEC). The CODEC is implemented as a data CODEC for processing packet data and an audio CODEC for processing an audio signal such as a voice. The audio processor 120 converts a digital audio signal into an analog audio signal through the audio CODEC, and plays the analog audio signal through a SPeaKer (SPK). The audio processor 120 converts an analog audio signal input from a MICrophone (MIC) into a digital audio signal through an audio CODEC.

The touch screen 130 includes a touch panel 134 and a display unit 136. The touch panel 134 senses touch input of a user. The touch panel 134 may be implemented with a touch sensor such as a capacitive overlay type, a resistive overlay type, an infrared beam type, and/or a pressure sensor. Besides the foregoing sensors, various other types of sensor devices capable of sensing contact or pressure of an object may be configured in the touch panel 134.

The touch panel 134 senses touch input of a user to generate a sensing signal, and transmits the generated sensing signal to the controller 160. The sensing signal contains coordinates data corresponding to a user's input touch. When the user inputs a moving touch, the touch sensor 131 generates and transmits a sensing signal having coordinate data of a moving path of the touch to the controller 160. The touch panel 134 may sense an edit command for editing an arranged state of icons and a restoration command for restoring the arranged state of icons to a previous state. The user input includes at least one of single touch input touching one point at a time, multi-touch input touching two points at the same time, or a drag input.

The display unit 136 may be a Liquid Crystal Display (LCD), an Organic Light Emitting Diode (OLED), or an Active Matrix Organic Light Emitting Diode (AMOLED), for example. The display unit 136 visually provides a menu of the terminal, input data, function setting information, and a variety of other information to a user. In an embodiment of the present invention, the display unit 136 displays icons.

In the following description, the mobile terminal 100 is configured to include a touch screen. In a mobile terminal without a touch screen, a touch screen 130 shown in FIG. 1 may be changed to perform only a function of the display unit 136. The input unit 140 receives input of a user for controlling the mobile terminal 100 and creates and transfers an input signal to the controller 160.

The input unit 140 may be implemented as a keypad with numeric and arrow keys, and may be implemented with a predetermined function key provided at one surface of the mobile terminal 100. The mobile terminal 100 may perform various operations through the touch screen 130. For example, the touch panel 134 may perform a function of an input unit 140. The input unit 140 may receive an edit command for editing an arranged state of icons and a restoring command for restoring the arranged state of icons to a previous state.

The memory 150 stores programs and data necessary for an operation of the mobile terminal 100, and may be divided into a program area and a data area. The program area may store a program for controlling an overall operation of the mobile terminal 100 and a program such as an Operating System (OS) booting the mobile terminal 100 provided in the mobile terminal 100 as a default. The program area of the memory 150 may store applications installed separately by the user, for example, game applications or social networking applications.

The data area is an area in which data created according to use of the mobile terminal 100 is stored, and may include images, moving images, phonebooks, and audio data. According to an embodiment of the present invention, the data area may store a gesture with a specific pattern as an edit command, and store an arrangement rule corresponding to the edit command. Further, the data area may store an icon arrangement state when icons are arranged according to the arrangement rule as a data value. Further, according to an embodiment of the present invention, the data area stores data regarding an installed time, an executed time, and an execution frequency of icons.

The controller 160 controls an overall operation of respective structural elements of the mobile terminal. According to an embodiment of the present invention, the controller 160 of the mobile terminal 100 determines whether user input received by the input unit 140 is an edit command for editing an arranged state of icons. The controller 160 may control a series of procedures for arranging and displaying icons according to an arrangement rule corresponding to an edit command. To do this, the controller 160 according to an embodiment of the present invention may further include an icon arrangement control unit 165.

The icon arrangement control unit 165 may set an edit command and an arrangement rule corresponding to the edit command. In an embodiment of the present invention, the edit command may be a gesture including at least one of drag input for the touch panel 134, single touch input, or multi-touch input touching two points at the same time. In an embodiment of the present invention, the edit command is drag input succeeding touch input. However, the present invention is not limited thereto. That is, the edit command may be implemented by continuous click inputs for a specific region or a button key, or soft key input included to set information display setting.

Moreover, in an embodiment of the present invention, the arrangement rule arranges icons according to an icon installation time order, a character order of icon titles, a time order of last executed icons, and an execution frequency order of the icons. The edit command and the arrangement rule may be previously set, and may be correct or updated by the icon arrangement control unit 165. Furthermore, the icon arrangement control unit 165 may receive a gesture with a specific pattern from the user, set the received gesture as an edit command, and control the set gesture associated with a specific arrangement rule.

Further, the icon arrangement control unit 165 may determine whether user input received by the input unit 140 is the edit command. The icon arrangement control unit 165 converts a pattern of the gesture into a coordinate data value of a touch location moving path, analyzes the converted coordinate data value of a touch location moving path, and determines whether it is a preset edit command.

For example, when the user input is drag input succeeding multi-touch, the icon arrangement control unit 165 analyzes coordinate data of a touch location moving path constituting the gesture and determines whether it is a preset edit command. Conversely, if the user input is touch input touching a displayed point of icons and touch cancellation input succeeding this, the icon arrangement control unit 165 determines that the gesture is not the edit command because it is a gesture for executing a corresponding icon. Further, when the user input is a straight drag input of a horizontal direction starting from a point, the icon arrangement control unit 165 determines that the gesture is not the edit command because it is a gesture for turning a screen page.

The icon arrangement control unit 165 controls to arrange and display icons according to an arrangement rule corresponding to the edit command. A graphic interface processing method for arranging icons will be described with reference to the accompanying drawings.

In addition, the icon arrangement control unit 165 may control a series of procedures that determine whether user input received by the input unit 140 is a restoration command, and restore an arranged state of icons to a previous state according to a type of a restoration command.

The restoration command refers to user input for restoring an arranged state of icons, and an input thereof is opposite to that of the edit command. For example, the icon arrangement control unit 165 sets drag input of a clockwise direction succeeding touch input of a point as the edit command, the restoration command is set as drag input of a counterclockwise direction succeeding touch input of a point.

According to an embodiment of the present invention, the icon arrangement control unit 165 may classify the restoration command into two types. A first restoration command is a command for restoring the mobile terminal to a state before edit, namely, an arranged state when the user receives the edit command, and a second restoration command is a command for restoring the mobile terminal to an arranged state when the user selects. In an embodiment of the present invention, the icon arrangement control unit 165 determines that repeated input of the first restoration command is the second restoration command. For example, if the icon arrangement control unit 165 sets that drag input of a clockwise direction after touch input of a point is an edit command, the first restoration command is drag input of counterclockwise direction succeeding touch input of a point, and the second restoration command is drag input of counterclockwise direction succeeding the touch input of the optional location. One example with respect to the relationship of the edit command, the first restoration command, and the second restoration command will be described below, with reference to the accompanying drawings.

As described above, the controller 160 and the icon arrangement control unit 165 are implemented as separate blocks and perform different functions. However, both units may perform the different functions. For example, the controller 160 may perform a specific function performed by the icon arrangement control unit 165.

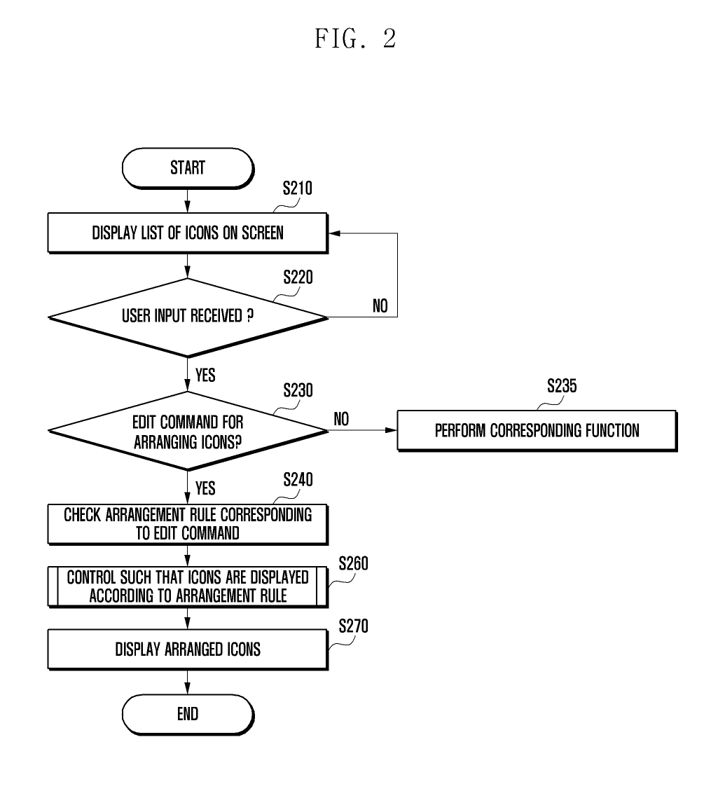

FIG. 2 is a flowchart illustrating a method for displaying icons in a mobile terminal 100.

First, a controller 160 of a mobile terminal 100 controls a display unit 136 to display a list of icons on a screen in Step 210. Here, icons may be displayed while turning a screen page according to the number of icons or as a folder icon including several applications. An input unit 140 receives user input in Step 220.

The controller 160 determines whether received user input is an edit command for arranging icons in Step 230. The controller 160 converts a pattern of a gesture into a coordinate data value of a touch location moving path, analyzes the converted coordinate data value of a touch location moving path, and determines whether the analyzed coordinate data value of a touch location moving path is a preset edit command.

According to an embodiment of the present invention, an edit command includes a drag input succeeding a touch input. For example, if the user input is drag input after multi-touch, the controller 160 analyzes coordinate data of a touch location moving path constituting the gesture and determines whether the analyzed coordinate data of a touch location moving path is a preset edit command. Conversely, if the user input is touch input touching a point which an icon is displayed and touch cancellation input after the touch input, the controller 160 determines that a gesture is not the edit command since this is the gesture for executing a corresponding icon. In the meantime, when the user input is straight drag input of a horizontal direction starting from an optional point, the controller 160 determines that a gesture is not the edit command because the gesture is a gesture for turning a screen page.

If the received user input is the edit command, the controller 160 checks an arrangement rule corresponding to the edit command in Step 240. If the received user input is not the edit command, the controller 160 may perform a function corresponding to the received input in Step 235.

The arrangement rule arranges icons according to an icon installation time order, a character order of icon titles, a time order of last executed icons, and an icon execution frequency order. The arrangement rule may be previously set by the controller 160, and the controller 160 checks the arrangement rule corresponding to the received edit command in Step 240.

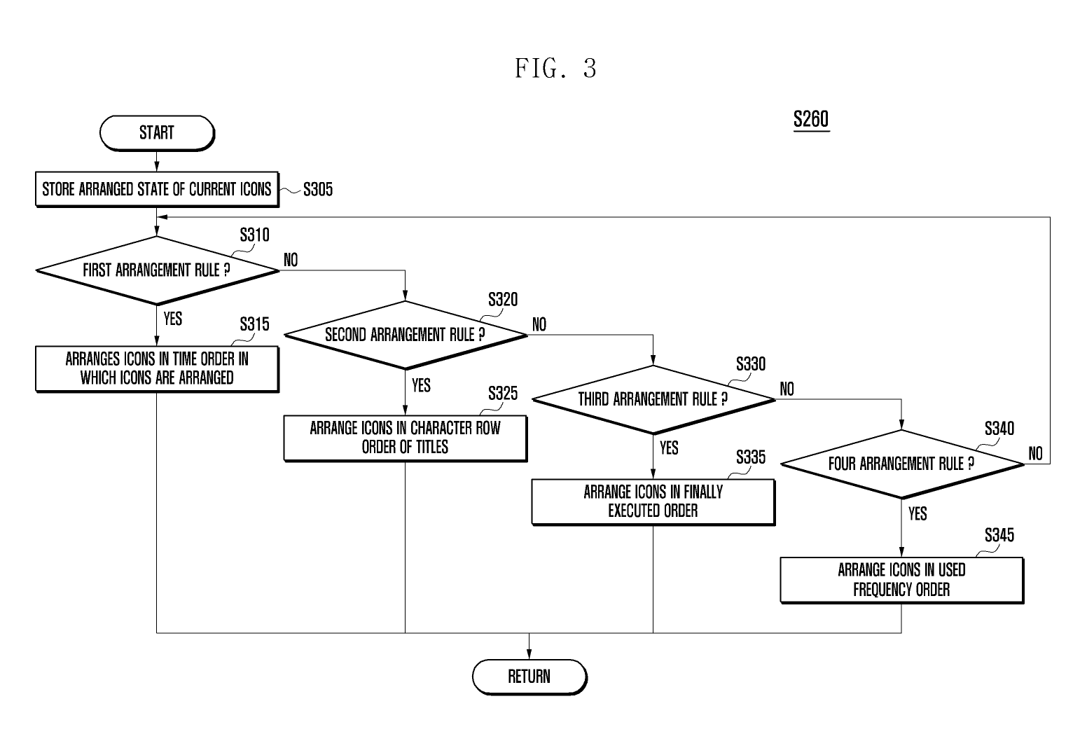

The controller 160 controls to display icons according to a preset arrangement rule in Step 260. One example of the operation in Step 260 in FIG. 2 is illustrated in FIG. 3.

Although is not illustrated in FIG. 2, the method for displaying icons according to an embodiment of the present invention may further include registering an edit command. In the registering step, the controller 160 may receive a gesture with a specific pattern from a user, and control the received gesture to be associated with a specific arrangement rule as the edit command. If only an edit command is registered, as described above, the restoration command is automatically registered with a pattern opposite to an input direction of an edit command. In addition, in the registering step, the controller 160 may receive user input and correct or update an edit command and an arrangement rule based on the received user input. The registering step is included before Step 230 of FIG. 2.

FIG. 3 is a flowchart illustrating a forming procedure of Step 260 of FIG. 2.

A controller 160 stores an arranged state of current icons, namely, an arranged state of icons when an edit command is received in a memory 150 in Step 305, for example, when a user wants to restore the mobile terminal to a previous state.

An arrangement rule corresponding to an edit command may be variously provided. For example, drag input of a clockwise direction after multi-touch input touching two points at the same time may correspond to an arrangement rule in which icons are arranged according to an installed time order. As another embodiment, straight drag input from a left lower end to a right upper end may correspond to an arrangement rule in which icons are arranged according to an order of icon titles. The arrangement rule may be previously set, and collected or updated by the controller 160.

The controller 160 performs Steps 310 to 340 according to an arrangement rule corresponding to the received edit command. The controller 160 arranges icons in a time order in which the icons are arranged according to a first arrangement rule in Step 315. The controller 160 may previously set or set with a separate edit command whether to arrange the icons in a reverse order or a forward order.

The controller 160 arranges the icons in a character order of icon titles in Step 325. The titles of icons are generally displayed at a lower end of icons. The order of icon titles represents a character order of icon titles, for example, in an alphabetical order. The controller 160 may previously set or set with a separate edit command whether to arrange the icons in a reverse order or a forward order of titles.

Next, the controller 160 controls to arrange the icons in a finally executed order in Step 335 and the controller 160 controls to arrange the icons in a used frequency order in Step 345. When the icon is a folder, execution or use of the icon refers to execution or use of the folder, namely, clicking the folder by the user. The controller 160 may previously set or set with a separate edit command whether to arrange the icons in an executed order, a reverse order or a forward order of the used frequency.

Although four arrangement rules are illustrated in FIG. 3, the present invention is not limited thereto. In an embodiment of the present invention, for convenience for the user, the icon arranged rules may be variously set. For example, the controller 160 may set whether to edit an arranged state of only icons displayed on a screen page input that the user inputs the edit command or to edit an arranged state of entire icons of all pages.

Referring back to FIG. 2, the controller 160 displays icons arranged according to the arrangement rule on the display unit 136 in Step 270. A method for processing a graphic interface with respect thereto will be described later.

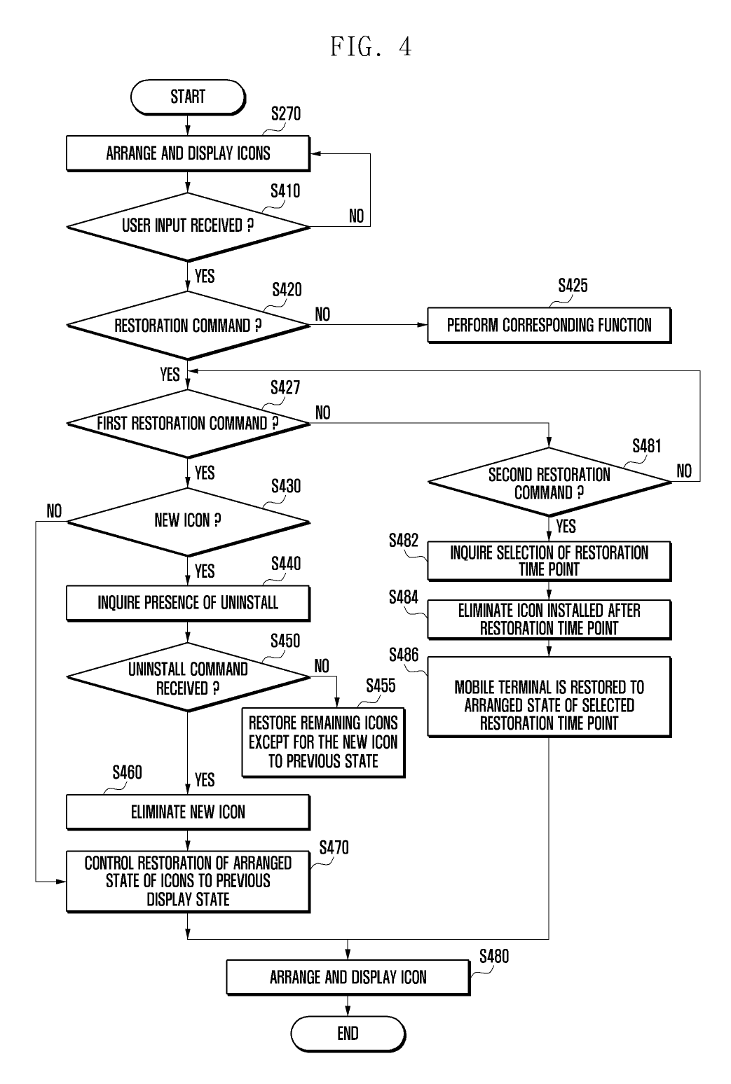

FIG. 4 is a flowchart illustrating a procedure for restoring an arranged state of icons according to an embodiment of the present invention. FIG. 4 starts from Step 270 of FIG. 2. That is, a controller 160 arranges and displays icons according to an arrangement rule corresponding to an edit command.

Next, the controller 160 senses whether user input is received in Step 410. The controller 160 determines whether the received user input is a restoration command for restoring an arranged state of icons in Step 420. The controller 160 analyzes coordinate data of a touch location moving path and determines whether received user input is a preset restoration command.

As described above, an input direction of the restoration command is opposite of that of the edit command. For example, if the edit command is drag input of a clockwise direction after a single touch, a restoration command is drag input of a counterclockwise direction after a single touch. However, the controller 160 may also set a different restoration command.

In Steps 427 and 481, the controller 160 checks a type of the restoration command. In an embodiment of the present invention, the controller 160 classifies the restoration command into two types. A first restoration command is a command for restoring the mobile terminal to an arranged state of Step 220, and a second restoration command is a command for restoring the arranged state of icons to an arranged state of a specific time-point selected by the user. As discussed above, an embodiment of the present invention is characterized that the second restoration command is repeated input of the first restoration command.

When a type of the restoration command is a first restoration command, the controller 160 determines whether a new icon exists in Step 430. Here, the new icon is an icon newly installed after arranging icons at Step 270. For example, an icon with respect to a game application is the new icon when icons are arranged according to an order of titles and a game application is newly installed. In general, the new icon is finally displayed on a screen.

If no new icon exists at Step 403, in Step 470 the controller 160 controls to restore the arranged state of the icons to a previous display state, namely, in Step 220. For example, where icons are arranged in an installed time order by using a clockwise direction drag after multi-touch as an edit command, if no new icon exists and drag input of a counterclockwise direction is received, the controller 160 restores the arranged state of icons to a previous state of arrangement according to the arrangement rule.

If a new icon exists at Step 430, the controller 160 controls the display unit 136 to display a screen inquiring presence of uninstall in Step 440. An uninstall command is a command for eliminating a new application. If the uninstall command is selected at Step 450, the controller 160 eliminates a corresponding icon while eliminating a new application in Step 460.

Conversely, if the uninstall command is not received, the controller 160 controls to restore the remaining icons except for the new icon to a previous state in Step 455. After the new icon is processed, the controller 160 controls to restore the icons to a previous state.

When a type of the restoration command is a second restoration command, the controller 160 controls the display unit 136 to display a screen inquiring selection of a restoration time-point in Step 482. For example, the restoration time-point may be selected for each day, each week, or each month. This allows a user to select a restoration time-point.

If an input unit 140 receives a restoration time-point selection command at Step 482, the controller 160 eliminates a corresponding icon while eliminating applications installed after the restoration time-point in Step 484.

Next, the controller 160 controls to restore the mobile terminal to an arranged state of a restoration time-point selected by the user in Step 486, and the controller 160 controls the display unit 136 to display a restored icon in Step 480.

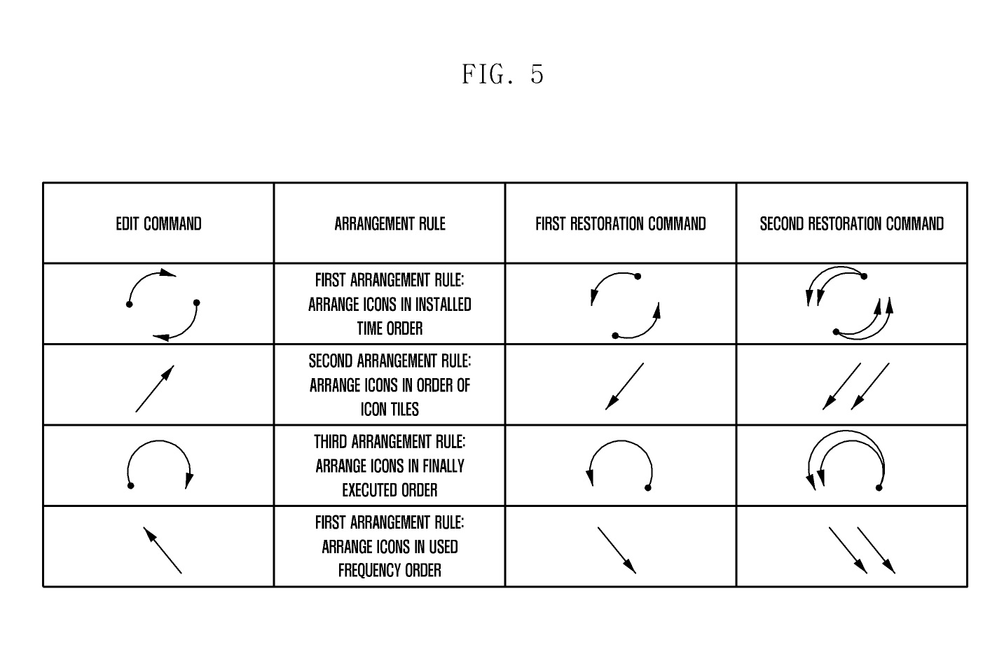

FIG. 5 is a diagram illustrating edit and restoration commands. Referring to FIG. 5, according to an embodiment of the present invention, input directions of the edit command and the restoration command are opposite of each other. The second restoration command is repeated input of the first restoration command.

For example, when an edit command is a drag input in a clockwise direction following a multi-touch input, by touching two points at the same time, the first restoration command is a drag input of a counterclockwise direction succeeding a multi-touch input and the second restoration command is two drag inputs of a counterclockwise direction succeeding a multi-touch input.

If an edit command is drag input in a straight direction from a left lower end to a right upper end, the first restoration command is a drag input in a straight direction from a left upper end to a left lower end. The second restoration command is performed by performing the first restoration command twice.

When the edit command is a drag input of a clockwise direction succeeding a single touch input point, the first restoration command is a drag input of counterclockwise direction succeeding a single touch input point. The second restoration command is two drag inputs of a counterclockwise direction succeeding a single touch input point.

If an edit command is a drag input in a straight direction from a right lower end to a left upper end, the first restoration command is a drag input in a straight direction from a right upper end to a left lower end. The second restoration command is performed by performing the first restoration command twice. Although four types of the edit command and the restoration command are illustrated in FIG. 5, the present invention is not limited thereto. The controller 160 may set the edit commands in other various ways, for convenience of the user.

For example, separate edit commands may be set where icons are arranged in a reverse order of an installed time order or in a forward order of the installed time order. Edit commands may be separately set where only an arranged state of icons displayed on a specific screen page is edited and where an arranged state of entire icons of all pages is edited.

In addition, the controller 160 may receive a gesture with a specific pattern from the user and register the received gesture as the edit command. If the edit command is registered, as illustrated previously, the restoration command is automatically registered with a reverse pattern of an input direction of the edit command. Further, the controller 165 may collect or update the edit command and the arrangement rule.

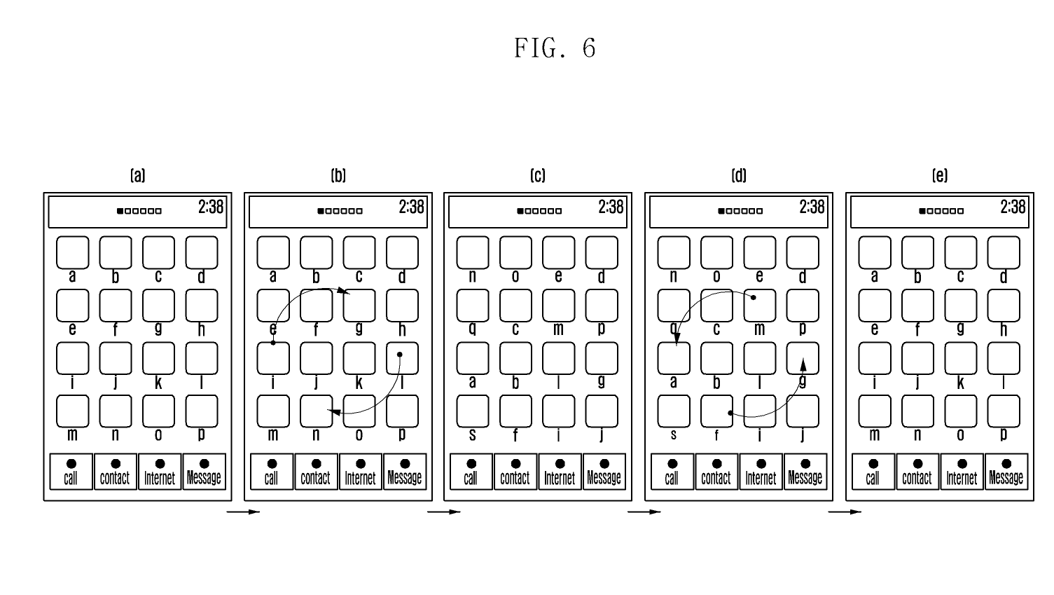

FIG. 6 is a diagram illustrating an example of a graphic interface for editing an arranged state of icons and restoring it to a previous state according to an embodiment of the present invention.

First, FIG. 6a is a diagram illustrating a state in which icons are displayed on a first page of a screen. As shown in FIG. 6a, the icon display screen includes at least one icon and titles of icons expressed at lower ends thereof.

FIG. 6b is a diagram illustrating a state receiving an edit command. FIG. 6b illustrates a scenario in which drag input of a clockwise direction succeeding a multi-touch input touching two points at the same time on a touch screen is used as the edit command. When the edit command corresponds to an arrangement rule arranging icons in an installed time order, as shown in FIG. 6c, icons of a corresponding page is arranged in an installed time order.

Next, the user inputs a first restoration command opposite of an input direction of the edit command to restore an arranged state of icons to a previous arranged state. In FIG. 6, a first restoration command is drag input of counterclockwise direction succeeding multi-touch, and FIG. 6d is a diagram illustrating a state receiving the first restoration command. Then, as shown in FIG. 6e, an icon display screen is restored in the same as in FIG. 6a being a state before it is arranged according to an arrangement rule.

As shown in FIG. 6, the controller 160 may set whether to edit an arranged state of only icons displayed on a specific page or an arranged state of entire icons.

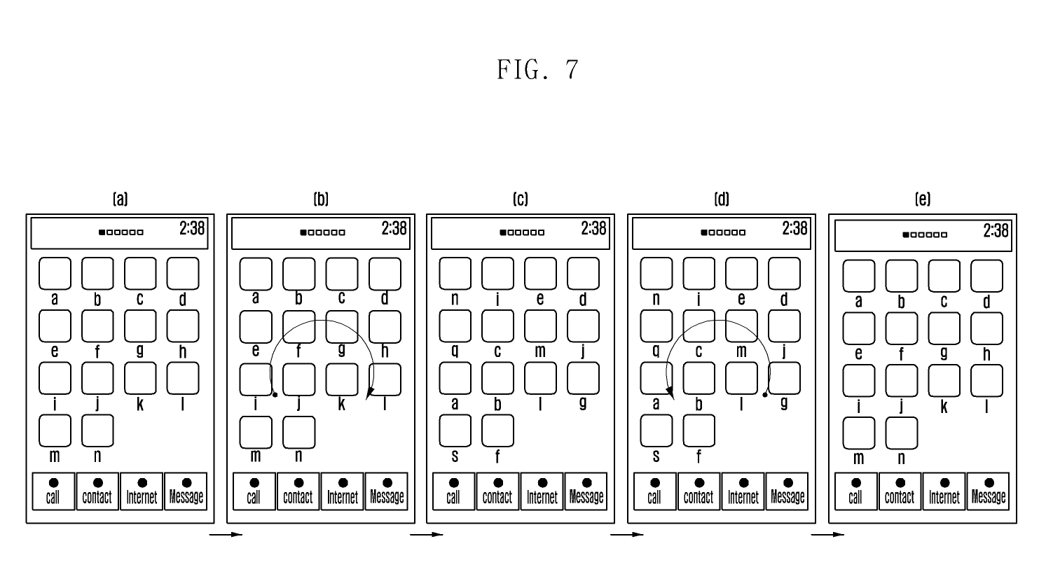

FIG. 7 is a diagram illustrating another example of a graphic interface for editing an arranged state of icons and restoring the arranged state of icons to a previous state according to an embodiment of the present invention.

First, FIG. 7a is a diagram illustrating a state displaying icons. FIG. 7b is a diagram illustrating a state receiving an edit command. FIG. 7b illustrates a scenario in which a drag input of a clockwise direction succeeding a single touch input, touching one point on a touch screen is used as an edit command. When the edit command corresponds to an arrangement rule arranging icons in a finally executed order, as illustrated in FIG. 6c, icons of a corresponding page are arranged in the finally executed order.

Next, the user inputs a first restoration command opposite of an input direction of an edit command to restore icons to a previous arranged state. In FIG. 7, a first restoration command is drag input of a counterclockwise direction succeeding a single touch, and FIG. 7b is a diagram illustrating a state receiving the first restoration command. Then, as illustrated in FIG. 7e, an icon display screen is restored in the same manner as in FIG. 7a being a state before the icons are arranged according to an arrangement rule.

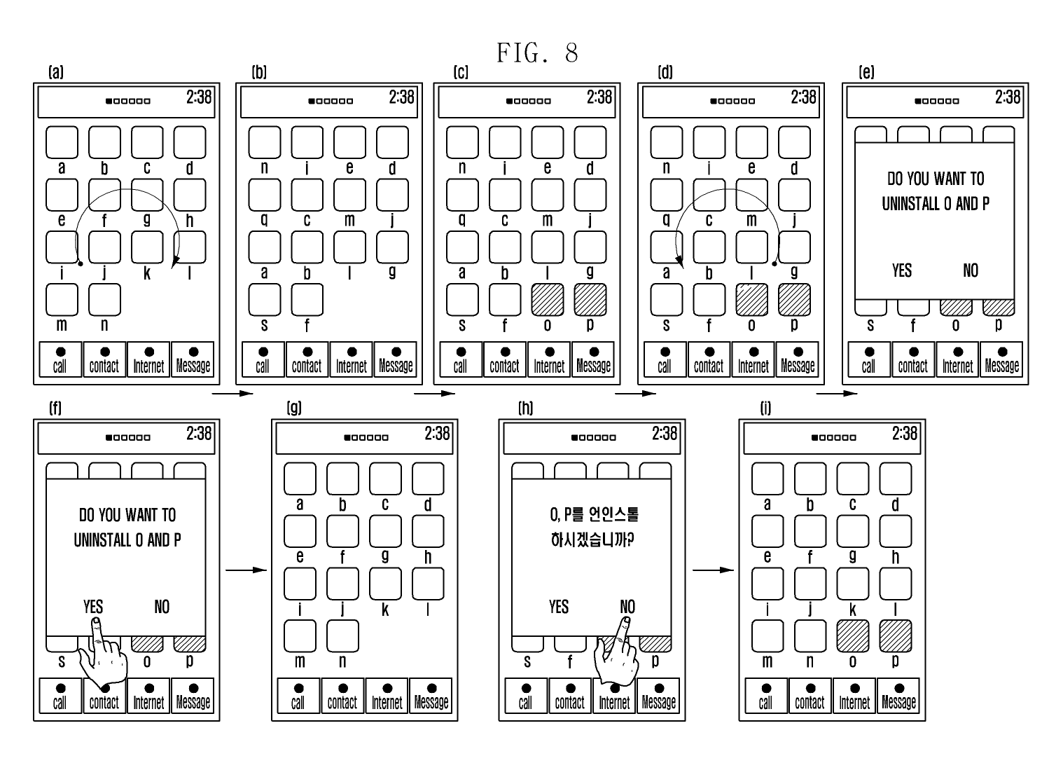

FIG. 8 is a diagram illustrating an example of a graphic interface for restoring an arranged state of icons to a previous state where a new icon exists. If drag input of a clockwise direction after a single touch is received in FIG. 8a, the controller 160 arranges and displays the icons in a finally executed order as illustrated in FIG. 8b. FIG. 8c is a screen newly installing new icons o and p after the user arranges the icons. In this case, the user inputs drag of a counterclockwise direction as illustrated in FIG. 8b so as to restore an arranged state of icons to a previous arranged state. In this case, the controller 160 inquires presence of uninstall with respect to new icons o and p in FIG. 8e. As illustrated in FIG. 8f, if the user inputs an uninstall command, the controller 160 eliminates the icons o and p and restores an arranged state of icons to a previous arranged state.

Conversely, as illustrated in FIG. 8h, if the user does not input an uninstall command, as illustrated in FIG. 8i, the controller 160 restores icons except for only the icons o and p to a previous arranged state.

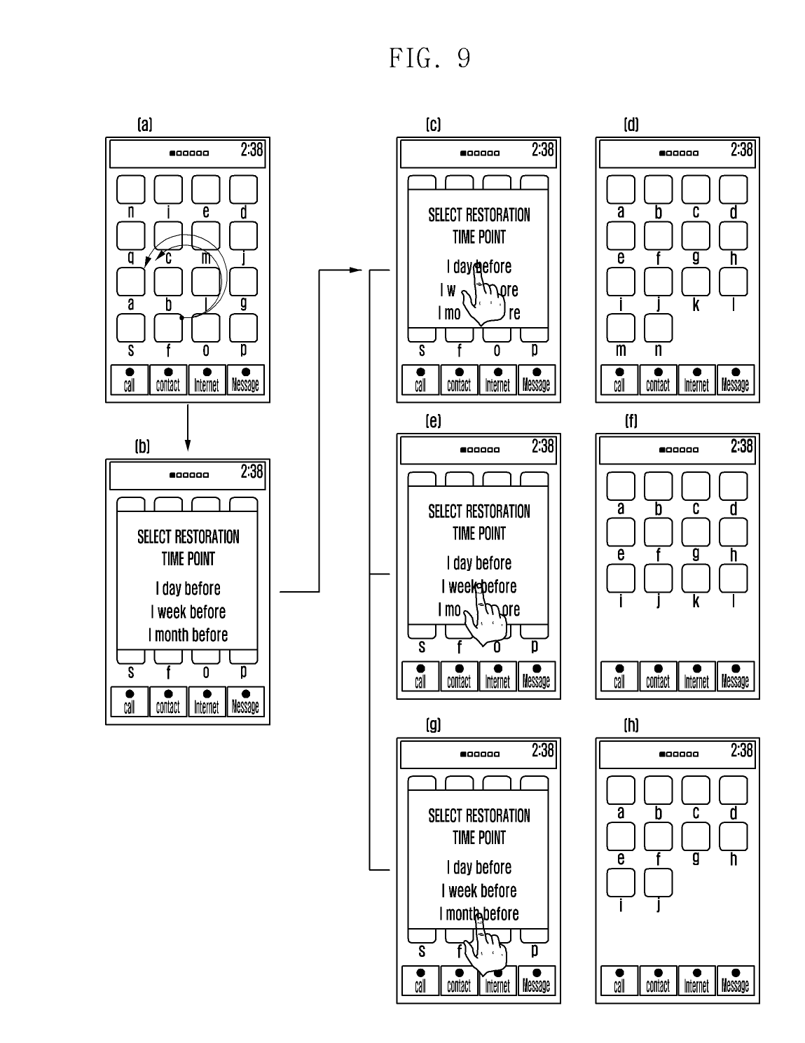

FIG. 9 is a diagram illustrating an example of a graphic interface for restoring an arranged state of icons to a restored time-point selected by a user. In FIG. 9a, if a second restoration command being drag input twice of a clockwise direction after a single touch, the controller 160 controls to display a screen inquiring selection of a restoration time-point, as illustrated in FIG. 9b. For example, the restoration time-point may be selected for each day, each week, or each month.

FIG. 9c illustrates a scenario in which a user selects a day before the current time as the restoration time-point. When icons o and p are newly installed within 24 hours from a selected time-point, the icons o and p are eliminated and remaining icons are restored to an arranged state one day ago and the restored icons are displayed. FIG. 9e illustrates a scenario in which the user selects one week before the current time as the restoration time-point. When icons o and p are newly installed within 24 hours from a selected time-point, the icons m, n, o, and p are eliminated as illustrated in FIG. 9f, and remaining icons are restored to an arranged state one week before the current time and the restored icons are displayed.

FIG. 9g illustrates a scenario in which a user selects one week before the current time as the restoration time-point. When icons k, l, m, n, o, and p are newly installed within one month from a selected time-point, icons k, l, m, n, o, and p are eliminated as illustrated in FIG. 9h and remaining icons are restored to an arranged state one month ago.

According to the present invention, an arranged state of icons may be edited and the edited icons may be displayed on a screen according to various arrangement rules by only a simple operation. Further, in the present invention, an input direction of an edit command for editing an arranged state of icons are opposite of that of a restoration command for restoring the icons to a previous state. Therefore, user convenience may be increased in searching icons and the user may intuitively recognize a method for arranging icons in a mobile terminal.

Although various embodiments of the present invention have been described in detail herein, it will be apparent to those of ordinary skill in the art that variations and modifications may be made without departing from the spirit and scope of the present invention, as defined by the appended claims.

What is claimed is:

1. A method for displaying icons, the method comprising:
displaying icons in an arranged state;
receiving an edit command for editing the arranged state of the icons;
checking an arrangement rule corresponding to the edit command; and
arranging and displaying the icons according to the arrangement rule.

2. The method of claim 1, further comprising:
receiving a restoration command for restoring the arranged state of the icons;
checking a type of the restoration command; and
restoring the icons to an arranged state of a time-point before receiving the restoration command, according to the type of the restoration command.

3. The method of claim 1, wherein the edit command includes a gesture input including at least one of a drag input, a single touch input touching one point, or a multi-touch input simultaneously touching a plurality of points.

4. The method of claim 2, wherein the restoration command includes a gesture input opposite of an input direction of the edit command.

5. The method of claim 2, wherein restoring the icons comprises:
restoring the icons to the arranged state of a time-point of receiving the edit command, when a type of the restoration command is a first restoration command; and
displaying the restored icons.

6. The method of claim 2, wherein restoring the icons comprises:
receiving an uninstall command for uninstalling a new install, installed after arranging and displaying the icons;
eliminating the new icon when receiving the uninstall command; and
restoring the icons to the arranged state of a time-point before receiving the restoration command; and
displaying the restored icons.

7. The method of claim 2, wherein restoring the icons comprises:
receiving a restoration time-point selection command, and selecting a specific time-point before receiving the restoration command, when the type of the restoration command is a second restoration command; and
restoring the icons to an arranged state of the selected specific time-point; and
displaying the restored icons,
wherein the second restoration command is a gesture performed by inputting a first restoration command a plurality of times.

8. The method of claim 7, further comprising eliminating icons installed after the selected restoration time-point, after receiving a restoration time-point selection command.

9. The method of claim 1, wherein the arrangement rule arranges icons according to at least one of an icon installation time order, a character order of icon titles, a time order of last executed icons, and an icon execution frequency order.

10. An apparatus for displaying icons, the apparatus comprising:
a display unit for displaying icons in an arranged state;
an input unit for receiving user input; and
a controller for determining whether the user input received by the input unit includes an edit command for editing the arranged state of the icons, checking an arrangement rule corresponding to the edit command when the user input is the edit command, and arranging the icons according to the arrangement rule.

11. The apparatus of claim 10, wherein the controller determines whether the user input received by the input unit is a restoration command, checks a type of the restoration command when the user input is the restoration command, and restores the arranged state of the icons to an arranged state before receiving the restoration command, according to the type of the restoration command.

12. The apparatus of claim 10, wherein the edit command includes a gesture input including at least one of a drag input, a single touch input touching one point, or a multi-touch input simultaneously touching a plurality of points.

13. The apparatus of claim 10, wherein the controller determines a gesture input opposite of an input direction of the edit command as the restoration command.

14. The apparatus of claim 11, wherein the controller restores the icons to an arranged state of a time-point of receiving the edit command, when a type of the restoration command is a first restoration command.

15. The apparatus of claim 11, wherein the controller determines reception of a command for uninstalling a new install, installed after arranging the icons according to the arrangement rule, eliminates the new icon when receiving the uninstall command, and restores the icons to the arranged state of a time-point before receiving the restoration command.

16. The apparatus of claim 11, wherein the controller receives a restoration time-point selection command, selecting a specific time-point before receiving the restoration command, when the type of the restoration command is a second restoration command, and restores the icons to an arranged state of a time-point of the selected specific time-point.

17. The apparatus of claim 16, wherein the controller determines the second restoration command when a gesture is performed by inputting a first restoration command a plurality of times.

18. The apparatus of claim 16, wherein the controller controls to eliminate icons installed after the selected restoration time-point.

19. The apparatus of claim 10, wherein the controller arranges icons according to at least one of an icon installation time order, a character order of icon titles, a time order of last executed icons, and an icon execution frequency order.
